(19) United States
(12) Patent Application Publication
(10) Pub. No.: US 2004/0064390 A1
(43) Pub. Date: Apr. 1, 2004

(54) User customizable statistical information system

(75) Inventor: Randy L. Pullen, Phoenix, AZ (US)

Correspondence Address: Mr. John D. Titus, The Cavanagh Law Firm, Ste. 2400, 1850 N. Central Avenue, Phoenix, AZ, 85004, US

(73) Assignee: WAGEWATCH, INC., Tempe, AZ

(21) Appl. No.: 10/256,944

(22) Filed: Sep. 26, 2002

(51) Int. Cl. G06F 17/60

(52) U.S. Cl. 705/35

(57) ABSTRACT

The present invention comprises a system for surveying and reporting of wage and benefit information, as well as other competitive economic data, to subscriber companies in a manner that permits flexibility in the statistical analysis performed on the data as well as the manner of reporting. A user is able to select which competitors will be used for comparison based on the date on which the survey data was entered for each competitor, and based on the facilities and personnel that a particular competitor may have in common with the user. Where the data entered is job salary and benefit data, users also have the flexibility to request reports by cross-industry occupation so that the data is not limited solely to the particular industry in question even if that industry competes with others for the same types of employees.

### BACKGROUND OF THE INVENTION

This invention relates generally to web-based information services. In particular this invention relates to the service of providing statistical wage and benefit data, as well as other competitive economic data, to subscriber companies.

Wage and benefit statistical services are well known in the art. Typically these services are provided on a subscription basis. A subscriber company is a company that has enrolled in the wage and benefit information service and belongs to an industry for which the data is collected and analyzed. Common examples of industries that use these subscription services include the hospitality industry, the restaurant industry and the healthcare industry. A hospitality company, for instance, is a company that owns properties such as hotels or resorts. After the hospitality company subscribes, the wage and benefit service collects company information that will become part of a large database. The data collected is the wage and benefit information that the hospitality company assigns to each occupation at a particular property. For instance, for the position of Concierge Manager, the information collected would include the minimum starting salary, midpoint, and maximum rate for each hotel. Once the hospitality company has completed the survey and has submitted the information, it receives a report with statistical analysis of its wages and benefits and a statistical comparison to the wages and benefits of its competitors. According to the prior art, the collection of data is done through paper forms that the subscriber company fills-out; then the data is manually entered into a computation system where statistical analysis is performed; and finally the bulk statistical results are printed and reported to each subscriber company.

Each subscriber company receives a report that corresponds to the previous year and contains data from all the participant subscriber companies. The statistical reports provide a basis for the company to understand the trends in the wage and benefit market and to make informed business decisions regarding their own hiring practices and plans of compensation. The individual identity information of each property is not disclosed in the report so as to avoid any chance that the information be used for the purpose of price-fixing. The statistical report contains bulk data from all the properties of the hospitality companies subscribed, and is not typically tailored to the individual property owner's specifications.

The processing of a hospitality company's wage and benefit data involves many steps that are susceptible to automation. Other survey systems that have done this automation process and provide with statistical data to their subscribers include: Mercer Human Resources Consulting (imercer.com) which offers compensation and benefit analysis of the market as a whole but does not provide dynamic statistical comparison to its subscribers.

While these systems of wage and benefit surveying provide a useful source of statistical data, they generally present limitations that have not been addressed until now. The first and most impacting limitation is the inability of the current systems to report statistical data customized to each property. The statistical report that the hospitality company receives has a pool of participating properties with heterogeneous characteristics. To illustrate this limitation, a hospitality company that is a medium size hotel with no restaurant service would find very marginal use in a statistical report that includes hotels of different sizes, including large hotels with restaurant service. Ideally, that medium size hotel should be analyzed against hotels of the same category. The second limitation is the indiscriminate level of access to subscriber company information that employees of that company may have. For instance, the human resources employees of the subscriber company should have data entry access to the system, but there is no need for those employees to have access to wage information of the human resources employees of competitor companies. The third limitation of current systems is that they do not allow for cross-industry comparison by occupation. For example, a health care company is limited to the wage information for a Laundry Operator of other companies within the health care industry. It does not have access to the wage information for Laundry Operators in other industries such as the hospitality industry, even though it may compete with the hospitality industry for those employees. Finally, the reports that the companies receive contain information only for the previous year (or other year in which the data was collected) thus confining subscriber companies to use information that may be outdated by the time the report is received.

What is needed is a web-based wage and benefit survey system that can provide the user with secure access levels to wage and benefit information of the subscriber company, the ability to compare wage and benefit information by occupation, and a more accurate statistical analysis of that data. A more accurate statistical analysis would be achieved by providing subscriber companies with the flexibility of selecting the competitors that will be used in the comparative irrespective of the age of the data.

### SUMMARY OF THE INVENTION

The present invention comprises a system for surveying and reporting of wage and benefit information, as well as other competitive economic data, to subscriber companies in a manner that permits flexibility in the statistical analysis performed on the data as well as the manner of reporting. In one embodiment, the system is web-based and its website consists of two main components: general information and secure access information. General information does not require validation to access and offers information about the service, costs, etc. Secure access information comprises two capabilities: submission and retrieval of wage and benefit information and account administration. The submission and data retrieval capability is intended for all authorized users of a subscriber company. The account administration component is only available to those company users who have the authority to add and edit other users' accounts. Users gain access through a validation method such as user name and password.

A subscriber company enters the competitive sensitive information, such as wage and benefit data, product or service pricing, or other data relevant to its facility. This data is stored in a central database accessible for calculation and statistical analysis. After the subscriber company has entered its information in the survey online forms, it has the capability to generate reports customized to its needs.

A user is able to select which competitors will be used for comparison. The service lists all facilities of the subscriber companies together with the date on which the data for each subscriber company was updated. When making its selection, the user must select at least five competitors to be used in the report. The user will have at least two criteria to select the competition: the date on which the survey data was entered for each competitor, and based on the facilities and personnel that a particular competitor may have in common with the user's property. Although conventional theory of statistics dictates that analysis should be done using all contemporaneous data, the present invention teaches away from that concept. Instead, the present invention (the web-based service) allows for calculation and analysis of statistical data that has been collected at different times. Where the data entered is job salary and benefit data, users also have the flexibility to request reports by cross-industry occupation. This is accomplished by basing the report on SOC (Standard Occupational Code) so that the data is not limited solely to the particular industry in question even if that industry competes with others for the same types of employees. Finally, the subscriber company is also able to administrate the level of access its users have.

Various other features, as described below, provide users and administrators with additional flexibility to facilitate the entry of data, viewing of wage and benefit data, and user management.

### BRIEF DESCRIPTION OF THE DRAWINGS

The above and other objects, aspects, features and attendant advantages of the present invention will become apparent from a consideration of the ensuing detailed description of presently preferred embodiment and methods thereof, taken in conjunction with the accompanying drawings, in which:

FIG. 1 shows the high-level architecture of the website in an illustrative embodiment incorporating features of the present invention.

FIG. 2 shows the high-level architecture of the administrative function in an illustrative embodiment incorporating features of the present invention.

FIG. 3 shows a screen print of a login interface in an illustrative embodiment incorporating features of the present invention.

FIG. 4 shows a screen print of an interactive user interface displaying navigational options related to a subscriber company in an illustrative embodiment incorporating features of the present invention.

FIG. 5 shows a screen print of an interactive user interface for selecting a property in an illustrative embodiment incorporating features of the present invention.

FIG. 6 shows a screen print of an interactive user interface for selecting an employment position in an illustrative embodiment incorporating features of the present invention.

FIG. 7 shows a screen print of an interactive user interface for entering data of an employment position in an illustrative embodiment incorporating features of the present invention.

FIG. 8 shows a screen print of an interactive user interface for selecting statistical analysis preferences in an illustrative embodiment incorporating features of the present invention.

FIG. 9 shows a screen print of an interactive user interface for selecting competitive properties and resetting the competitive set in an illustrative embodiment incorporating features of the present invention.

FIG. 10 shows a screen print of an interactive user interface for displaying wage information in an illustrative embodiment incorporating features of the present invention.

FIG. 11 shows a screen print of an interactive user interface for selecting report styles in an illustrative embodiment incorporating features of the present invention.

FIG. 12 shows a screen print of an interactive user interface for entering an SOC code in an illustrative embodiment incorporating features of the present invention.

FIG. 13 shows a screen print of an interactive user interface for displaying cross-industry analysis report in an illustrative embodiment incorporating features of the present invention.

FIG. 14 shows a screen print of an interactive user interface for selecting account administration options in an illustrative embodiment incorporating features of the present invention.

FIG. 15 shows a screen print of an interactive user interface for selecting a user to edit or for adding a new user in an illustrative embodiment incorporating features of the present invention.

FIG. 16 shows a screen print of an interactive user interface for selecting data access restrictions for users in an illustrative embodiment incorporating features of the present invention.

FIG. 17 shows a screen print of an interactive user interface for selecting property access restrictions for users in an illustrative embodiment incorporating features of the present invention.

FIG. 18 shows a screen print of an interactive user interface for entering user information in an illustrative embodiment incorporating features of the present invention.

### DESCRIPTION OF PREFERRED EMBODIMENTS AND METHODS

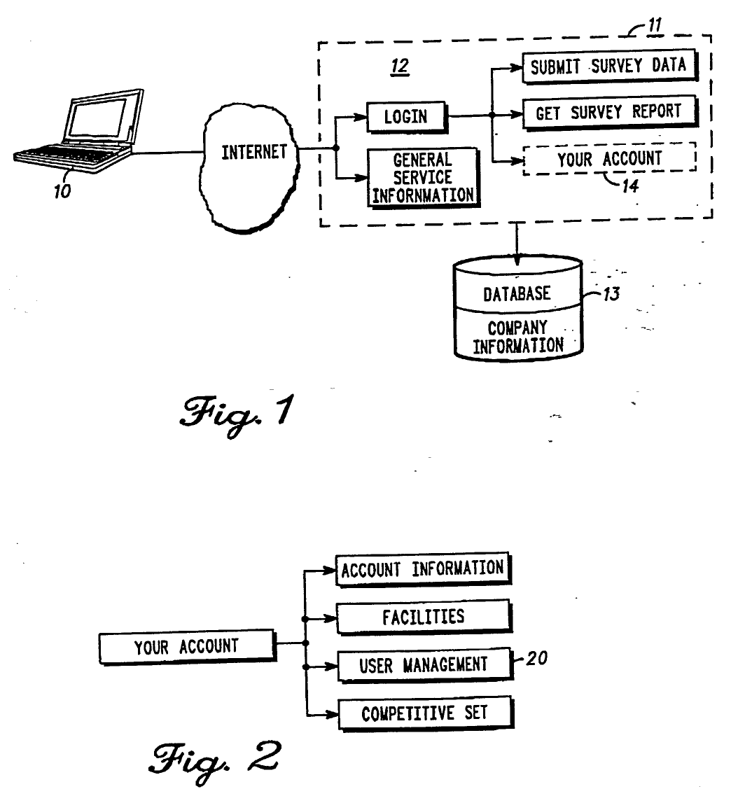

The present invention comprises a system for collecting and reporting wage and benefit data, as well as other competitive sensitive data such a product or service pricing, from subscriber companies. The illustrative embodiment of the present invention disclosed herein is an online Internet-based system (i.e. website) for comparing wage and benefit information that integrates an Internet browser as the interface to enter data, view statistical results and manage users. The client-computer 10, where the browser resides, interfaces through the Internet with the server-computer 11, where the system 12 resides. As shown in FIG. 1, the server computer 11 interacts with the database 13 containing company information. Similarly, the account administration capability is shown in the dotted box for “Your Account” 14. This option is not available to regular company users, rather, it is only available to company user-account administrators. FIG. 2 shows an expanded view of options in managing a company's account. Significantly, the option “User Management” 20 provides with user-account administration capability, which is more fully described hereinafter.

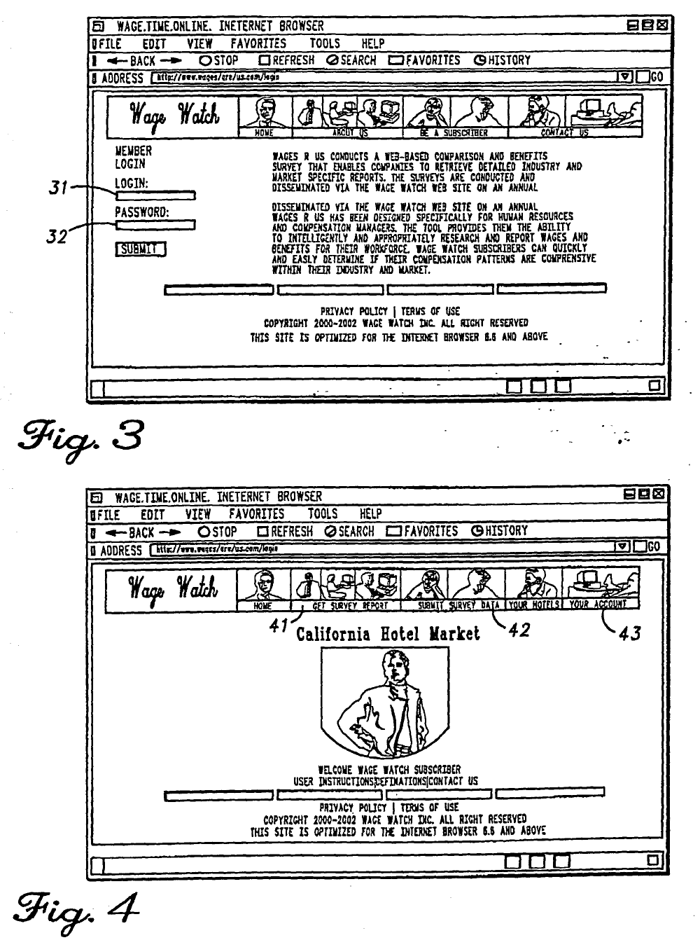

As shown in FIG. 3, the illustrative embodiment has a secure access system, which allows each company to access only its own raw data, thus preventing other companies from accessing its data. A second level of security is the restricted access to different users within one company (described below in the administrative site section). This dual security system is achieved by the use of a field for entering conventional login names 31 and a field for entering conventional passwords 32. Each subscriber company assigns login names and passwords to each of its users.

As shown in FIG. 4, once a user gains access, the company's “home page” a market web page appears offering interactive options. The web page contains the options of entering survey data (i.e. “Submit Survey Data”) 41, retrieving a report (i.e. “Get Survey Report”) 42, and, if logged in as an authorized company administrator, managing the information about company's accounts (i.e. “Your Account”) 43.

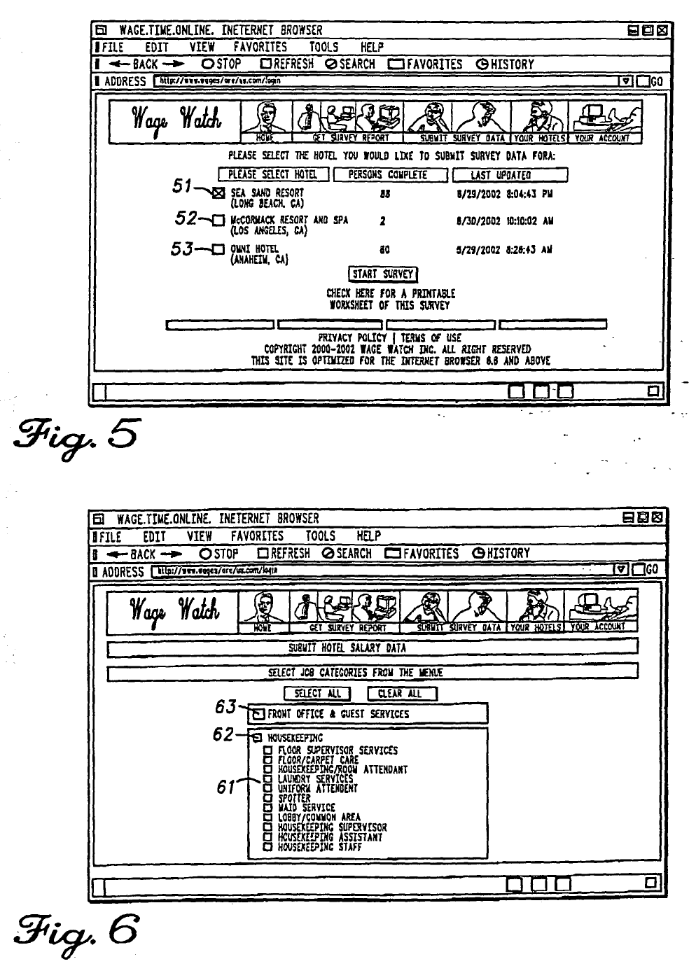

If the user selects the option of submitting data, the facilities belonging to the subscriber company will be listed for selection and the user selects the facility for which survey data will be entered. In the illustrative embodiment, the subscriber company is in the hospitality industry. Accordingly, the facilities are hotel and resort properties. Other industries would display different properties such as hospitals or restaurants. FIG. 5 is an exemplary user's screen for a hospitality company showing a list of hotels 51, 52, and 53 to be selected. In the example, the user has selected “Sea Sand Resort” as the property to be updated. Once the property has been selected, the user has the option of selecting the occupation for which it wants to submit data. FIG. 6 illustrates the interactive web page that allows such selection. Categories of employment, such as “Front Office & Guest Services” 63, and “Housekeeping” 62, are listed with the option of being expanded to detailed lists of occupations such as “Housekeeping” 62. Likewise, each expanded category may be collapsed to hide its detailed list of occupations. In FIG. 6, the employment category of “Housekeeping” 62 has been expanded to show all of the detailed occupations including “Housekeeper/Room Attendant” 61, which has been selected from the expanded occupational list of that category. This feature is particularly useful when a user wants to update the information of a few employees without having to go through a large package of paper forms to update its company's data.

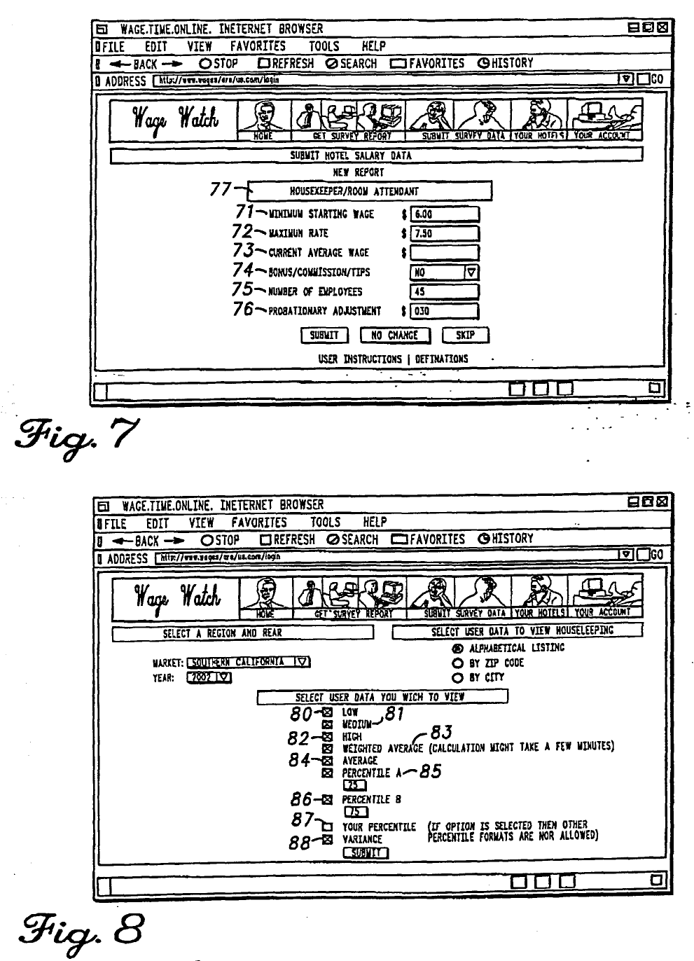

Once the user has selected the occupations to be updated, the system displays a form such as described in FIG. 7. The wage data for an hourly position (in this example a “Housekeeper/Room Attendant”) includes “Minimum Starting Wage” 71, Maximum Rate 72, Current Average Wage 73, Bonus/Commission/Tips 74, Number of Employees 75, Probationary Adjustment 76. Recognizing that companies may differ in the titles used for different occupations, the system provides for a description 77 of the occupation so that the data entered is consistent with that of other companies. Besides entering Hourly Position wage data (as described in the example above), the survey consists of other type of information such as Hourly Position benefit data, Salary Position wage data, and Salary Position benefit data. The user has the option of entering any of these data by selecting the type of survey in the survey menu under reference 42 of FIG. 4.

With reference again to FIG. 5., at the market web page, the user may select the option of getting a survey report 42. Once this option is selected, the user is able to dynamically customize the report to show specific data as described more fully hereinafter. First, the user is required to select a property owned by the company. In the example, the user has selected “Sea Sand Resort” as the property to be analyzed. The property selection presented to the user is similar to that for entering data described in FIG. 5. Also similar to the surveying mechanism, categories of employment FIG. 6, with the mechanism of expansion or collapse of the menus, are subsequently presented to the user. Much like in the surveying section, the ability to select particular occupations, for statistical comparison to competitors' occupations, is a powerful tool. By way of example, if a user selects “Housekeeper/Room Attendant” 61 from employment category of “Housekeeping” 62, the system will report the statistical information only of the occupation Housekeeper/Room Attendant of other companies and compare that to the Housekeeper/Room Attendant data of the user's company.

Another feature that allows for flexibility in the dynamic reporting of data is the ability to select which statistical data will be part of the report. In FIG. 8, the system displays optional types of statistical data that can be reported. The option list comprises “Low” 80, “Median” 81, “High” 82, “Weighted Average” 83, “Average” 84, “Percentile A” 85, “Percentile B” 86, “Your Percentile” 87, and “Variance” 88. The user has the option of selecting all or any of these options.

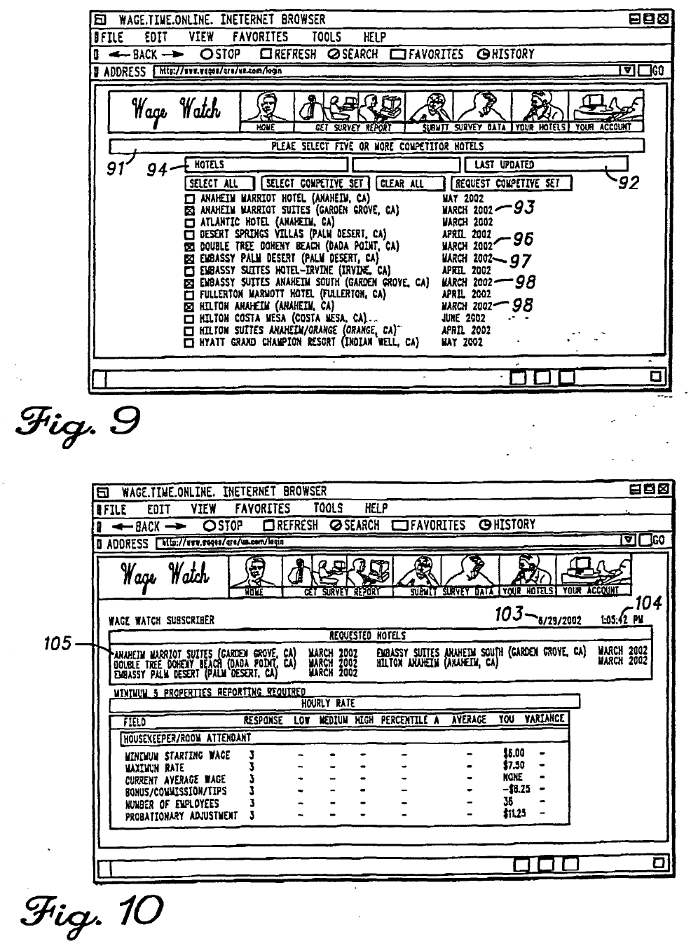

The data sample used for each of these statistical options will be taken from the competitive set of properties selected by the user. An illustration of this selection is shown in FIG. 9, which lists all the subscribed Hotels in alphabetical order. In order to preclude the possibility that data could be used for the purpose of engaging in anti-competitive price-fixing, users are required to select at least five competitors' properties 91 for the report. The ability to select properties gives each subscriber company an unprecedented tool for marketing and hiring decisions in what the users considers to be its competitive market. In the illustrative example of FIG. 9, the user has selected a group of hotels that it believe are characteristically similar to the property previously selected, “Sea Sand Resort.” The selection of similar properties provides for a more refined, accurate and useful statistical report to each company. The system allows for a dynamic or static selection of properties. The static selection is achieved by having a predefined set of competitor's properties that the user saves as it's preferred competitive set. Every time a user wants to generate a report, the system will have stored the predefined set of competitive properties (i.e. “Competitive Set”) 94 for its immediate use. Alternatively, dynamic selection of properties is carried out interactively based on the user selection of competitive properties based on its perception of the similarity of competitive properties (as described above). This may be based on many factors, including the company's perception of geographic competitiveness or the vintage of the data available for comparison. For instance, if the user in FIG. 9 wants to compare itself to hotel data that was entered on the month of March 2002, the user may select those properties such as 93, 96, 97, 98, 99 as long as there are five or more properties that were updated in March 2002. The user may also select properties that have been updated at different dates. As a result, the present invention teaches away from what conventional of statistics teaches. While statistics inculcate that data samples used in a statistical calculation (e.g. median, average, etc.) be of compatible dates, the present invention offers its users the capability of selecting data samples that are not chronologically similar.

The generated report contains all the user-customized features. In the hotel example, FIG. 10 depicts the presentation of the report contents. The report is stamped with the date 103, and the time 104 at which it was generated. It also lists the competitive properties selected 105 and the data for each position previously selected. FIG. 10 displays the wage information for a “Housekeeper/Room Attendant” with a column for each of the selected statistical data.

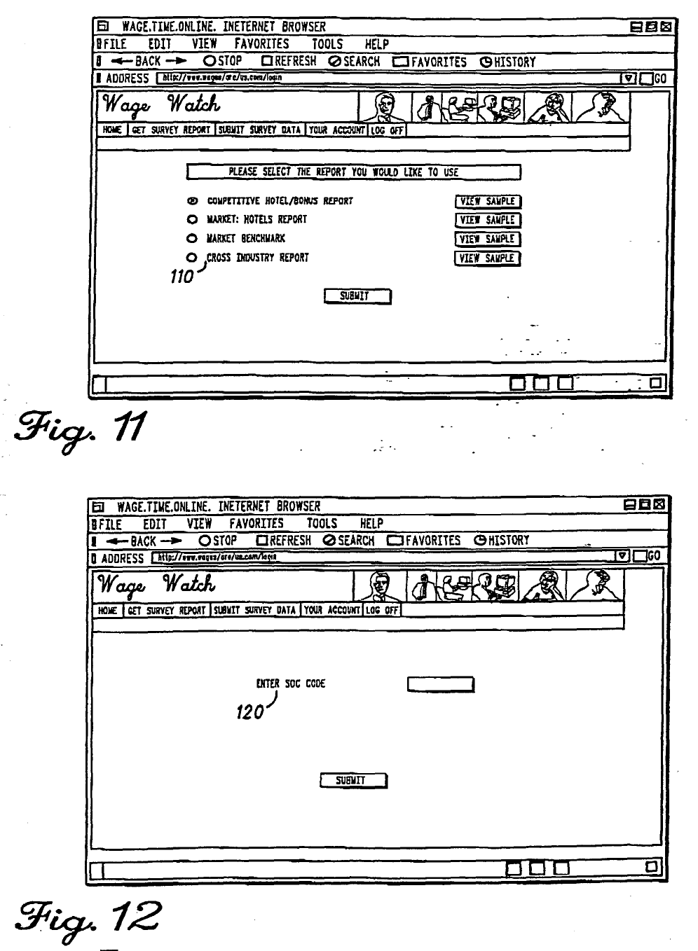

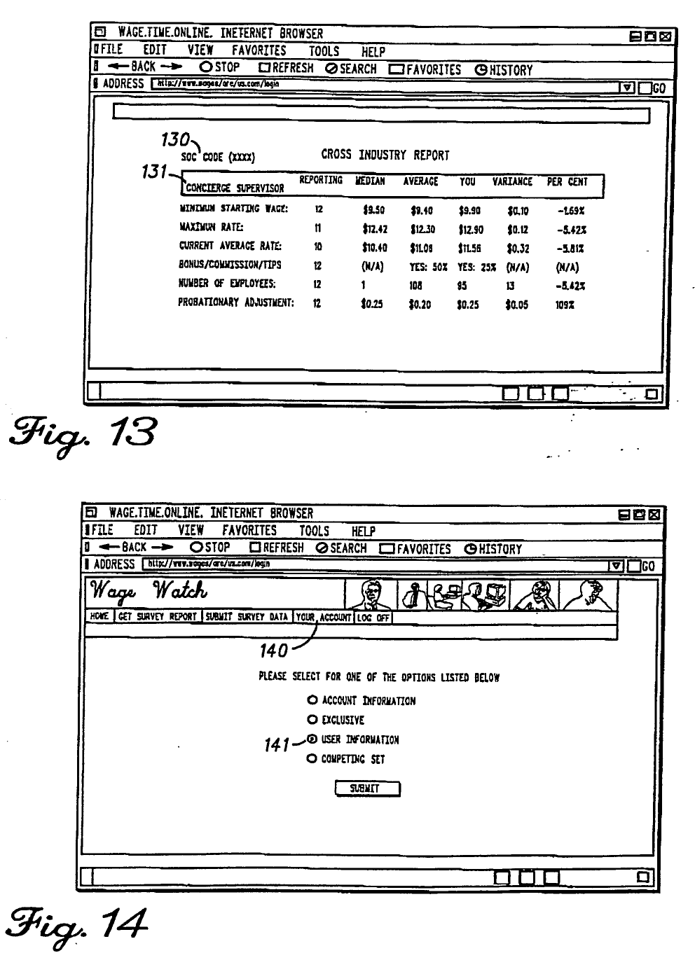

As show in FIG. 11, a user may generate reports of occupations that are equivalent across industries by selecting a cross-industry report 110. Thus, a user may compare an occupation within its company against an occupation denominated by an SOC code. The user selects an occupation using the selection mechanism illustrated in FIG. 6; and subsequently, as illustrated in FIG. 12, the user enters an SOC code for comparison 120. Also, the statistical data options are selected as described in FIG. 8. FIG. 13 shows a report for a company occupation “Concierge Supervisor” 131, compared to a cross industry occupation nominated by the SOC code 130.

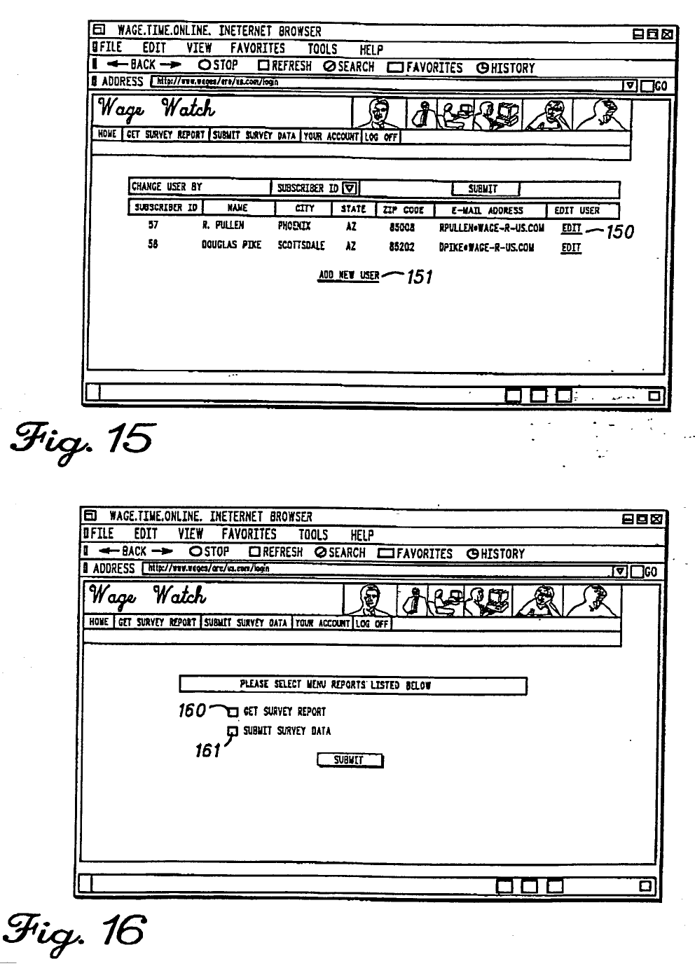

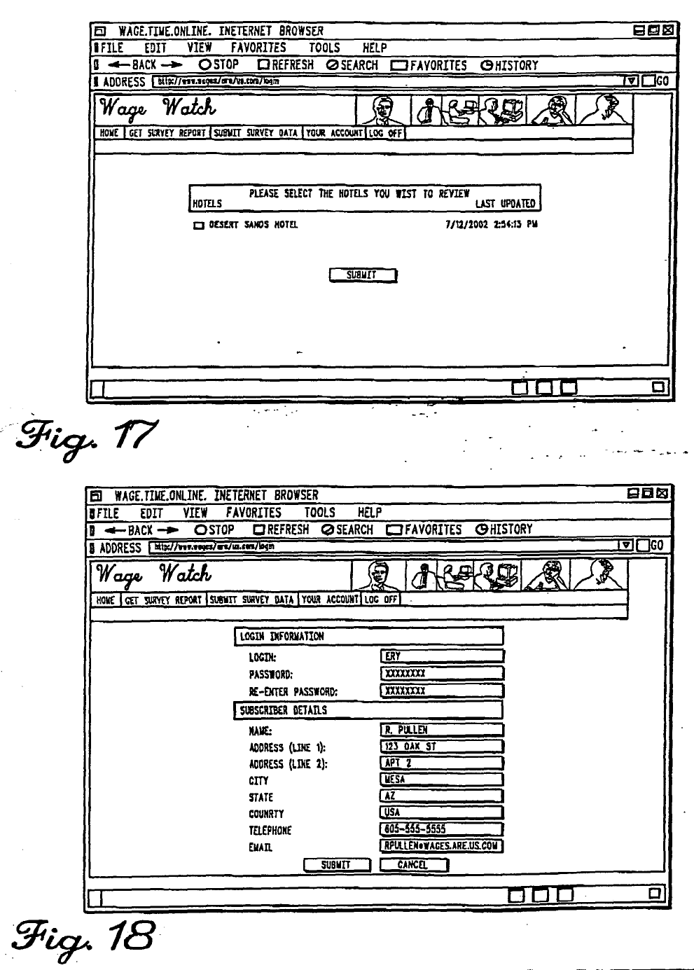

As shown in FIG. 14, a subscriber company may manage its users, and their access to competitive companies' information and survey data through an additional option “Your Account” 140. The illustrative example shows the options available for the user account manager. “User Management” 141 is the option that provides with the capability of adding new users or editing existing users. FIG. 15 shows a list of users under the subscriber company. The administrator can existing users (i.e. “Edit”) 150, or it can add a new user (i.e. “Add New User”) 151. As described in FIG. 16, when editing or adding a user, the user administrator may grant or restrict the operational ability of the user being edited or added. Thus, the user administrator may allow the user to generate reports 160 or submit survey data 161, or both. The user administrator may also grant or restrict access to data from particular hotels as described in FIG. 17. This function is particularly useful for a chain of hotels, because the headquarters can view data from all properties, but each property manager is restricted to viewing data from his/her own property only.

Finally, as in FIG. 18, the personal and account information of each user may also be updated or entered by the user administrator.

Although certain illustrative embodiments and methods have been disclosed herein, it will be apparent form the foregoing disclosure to those skilled in the art that variations and modifications of such embodiments and methods may be made without departing from the true spirit and scope of the invention. For example, another embodiment of this invention may include a software application implemented to interface with the Internet and directly query and update the corresponding data in the server; thus, an Internet browser would not be used as a user interface. Similarly, although the illustrative embodiment discloses a wage and benefit comparison system, the invention is useful for performing analysis of any type of competitive sensitive information such as comparison pricing of goods or services. Accordingly, it is intended that the invention shall be limited only to the extent required by the appended claims and the rules and principles of applicable law.

What is claimed:

1. A system for interactive exchange of competitive economic information of a plurality of subscriber facilities, said system comprising:
data entry means for collecting competitive economic information for said plurality of subscriber facilities, said data entry means comprising means capable of receiving said competitive economic information irrespective of the date said competitive economic information is inputted;
storage means for storing said competitive economic information together with data indicative of the date said competitive economic information was inputted;
means for interactively selecting a competitive set, said competitive set comprising at least five of said plurality of subscriber facilities;
means operatively connected to said storage means for performing a statistical analysis of the competitive economic information of said competitive set and providing results, said statistical analysis including calculation of at least the average of the competitive economic information of said competitive set;
display means for communicating said results of said statistical analysis to a user.

2. The system of claim 1, wherein:
said competitive economic information comprises wage data.

3. The system of claim 1, wherein:
said competitive economic information comprises product pricing information.

4. The system of claim 1, wherein:
said competitive economic information includes hourly position wage data and salaried position wage data.

5. The system of claim 1, wherein:
said means for interactively selecting a competitive set includes means for selecting at least five of said plurality of subscriber facilities based on geographical location.

6. The system of claim 1, wherein:
said means for interactively selecting a competitive set includes means for displaying the date that each of said plurality of subscribers last inputted the competitive economic information for each of said plurality of subscriber facilities, and further includes means for selecting at least five of said plurality of subscriber facilities based on the date said competitive economic information was last inputted.

7. The system of claim 1, further comprising:
means for storing said competitive set for later recall.

8. The system of claim 1, further comprising:
means for granting and restricting access levels, said access levels including, entry of competitive economic information only, entry of competitive economic information and viewing of said results of said statistical analysis for a single facility only, and entry of competitive economic information and viewing of said results of said statistical analysis for multiple facilities.

9. The system of claim 1, wherein said competitive economic information comprises wage data, said system further comprising:
means for interactively selecting a competitive job set, said competitive job set comprising at least five employee positions having similar job descriptions irrespective of industry;
means operatively connected to said storage means for performing a statistical analysis of the competitive economic information of said competitive job set and providing results; and display means for communicating said results of said statistical analysis of said job set to a user.

10. The system of claim 9, wherein:
said means for interactively selecting a competitive job set comprises means for selecting employee positions based on Standard Occupational Codes.

11. A system for interactive exchange of competitive economic information of a plurality of facilities belonging to a plurality of subscribers, said system comprising:
a user system for entering competitive economic information for said plurality of facilities;
a host system having a input for receiving said competitive economic information and having storage media capable of storing said competitive economic information together with a date stamp indicative of the date on which such competitive economic information was received, said host system further comprising a processing unit capable of receiving and executing instructions to interactively select a competitive set comprising at least five of said plurality of facilities and, in response to said instructions, perform a statistical analysis of the competitive economic information of said competitive set and provide results including calculation of at least the average of the competitive economic information said competitive set;
said user system further comprising a display for communicating said results of said statistical analysis to a user.

12. The system of claim 11, wherein:
said competitive economic information comprises wage and benefit data.

13. The system of claim 11, wherein:
said host system further includes storage media capable of storing the geographical location of each of said plurality of facilities and wherein said user system includes input for selecting a competitive set based on geographic location.

14. The system of claim 11, wherein:
said user system includes input for selecting a competitive set based on said date stamp indicative of the date on which such competitive economic information was received.

15. The system of claim 11, wherein:
said host system further includes means for granting and restricting access levels, said access levels including, entry of competitive economic information only, entry of competitive economic information and viewing of said results of said statistical analysis for a single facility only, and entry of competitive economic information and viewing of said results of said statistical analysis for multiple facilities.

16. The system of claim 11, wherein said competitive economic information is wage data and wherein:
said host system further includes storage media capable of storing job descriptions and wherein said user system includes input for selecting a competitive set based on job descriptions irrespective of industry.

17. The system of claim 16, wherein:
said job description includes the Standard Occupational Codes for said job descriptions.

18. A method for interactively exchanging competitive economic information comprising wage data for a plurality of subscriber facilities, said method comprising:
inputting competitive economic data to build a database of information of said subscriber facilites;
storing said competitive economic data together with data indicative of the date said competitive economic data was inputted;
selecting a competitive set of subscriber facilities, said competitive set comprising at least five of said subscriber facilities selected based on at least one criteria selected from the group consisting of geographic location, data indicative of the date the competitive economic data was inputted, and job description;
calculating statistical data based on said competitive set, said statistical data including the average wage of at least one job description in said competitive set; and
displaying said statistical data.

19. The method of claim 18, further comprising:
granting and restricting access levels for a plurality of users, said access levels including, entry of competitive economic information only, entry of competitive economic information and viewing of said results of said statistical analysis for a single facility only, and entry of competitive economic information and viewing of said results of said statistical analysis for multiple facilities.

20. The method of claim 18, wherein:
said job description comprises the Standard Occupational Code for each job.

21. A system for interactive exchange of competitive economic information comprising wage or benefit information for of a plurality of subscriber facilities, said system comprising:
data entry means for collecting competitive economic information for said plurality of facilities, said data entry means comprising means capable of receiving said competitive economic information irrespective of the date said competitive economic information is inputted;
storage means for storing said competitive economic information together with data indicative of the date said competitive economic information was inputted;
means for interactively selecting a competitive job set, said competitive job set comprising at least five employee positions having similar job descriptions irrespective of industry;
means operatively connected to said storage means for performing a statistical analysis of the competitive economic information of said competitive job set and providing results; and display means for communicating said results of said statistical analysis of said job set to a user.
